(19) United States
(12) Patent Application Publication
(10) Pub. No.: US 2015/0172229 A1
(43) Pub. Date: Jun. 18, 2015

(54) SYSTEM AND METHOD FOR CONTEMPORANEOUS MESSAGING

(71) Applicant: Megel Brown, Marina Del Rey, CA (US)

(72) Inventor: Megel Brown, Marina Del Rey, CA (US)

(21) Appl. No.: 14/466,589

(22) Filed: Aug. 22, 2014

Related U.S. Application Data
(60) Provisional application No. 61/916,202, filed on Dec. 14, 2013.

(51) Int. Cl. H04L 12/58; H04L 12/24

(52) U.S. Cl. CPC H04L 51/04; H04L 41/22

(57) ABSTRACT

The invention relates generally to a system and method of exchanging information over a network, and more particularly, but not exclusively, a system and method of contemporaneously exchanging information between communication devices, for example, a mobile device, personal computer, or server. That is, the present invention particularly, but not exclusively, relates to a system and method of exchanging information between users' communication devices, wherein the disclosure of a sender's transmitted information to an intended receiver is conditioned upon the intended receiver's transmission of a communication or and/or other information in response to an alert of the sender's transmission.

### BACKGROUND OF THE INVENTION

1. Field of Invention

The invention relates generally to a system and method of exchanging information over a network, and more particularly, but not exclusively, a system and method of contemporaneously exchanging information between communication devices, for example, a mobile device, personal computer, or server. That is, the present invention particularly, but not exclusively, relates to a system and method of exchanging information between users' communication devices, wherein the disclosure of a sender's transmitted information to an intended receiver is conditioned upon the intended receiver's transmission of a communication or and/or other information in response to an alert of the sender's transmission.

2. Description of the Related Art

Services available to transmit messages and other information over mobile communications networks vary, and include, for example, the Short Message Service (SMS), Enhanced Message Service (EMS), and Multimedia Message Service (MMS). Using these services and others, mobile device users are able to communicate various types of messages, including, for example, text messages, voice messages, picture messages, video messages, location messages, and e-mail, and combinations of the foregoing. These services may be available to those using other communication devices, for example, personal computers or computer tablets.

The growth in the availability of third Generation (3G) and fourth Generation (4G) mobile communication networks and devices equipped to operate over such networks has significantly increased the speed at which mobile device users can transmit and receive data, including e-mail and text, voice, and other multimedia messages. The popularity of communicating by mobile device messages, especially text and multimedia messages, continues to increase. One source estimates that 96.4% of smartphone users send text messages on their devices.

Given the popularity of messaging via mobile devices, in particular the popularity of text and multimedia messaging, various applications and services have emerged to facilitate or enhance mobile device messaging. These services include, for example, Kik, Line, WhatsApp Messenger, and Google Voice. These services may offer cross-platform mobile messaging applications to exchange communications without the need to pay for SMS. These applications or services may also help to contextualize and personalize chat conversations.

In another example, Blackberry and Apple, Inc. offer messaging services, Blackberry Messenger and iMessages, respectively, which facilitate messaging between those using Apple or Blackberry devices, respectively. Further, some messaging applications, such as Google Talk, may be accessed and used via personal computer.

A common deficiency among these examples is that they do not necessitate a contemporaneous exchange of communications between the sender and receiver via mobile or other communication devices. Stated differently, a receiver's ability to perceive a communication or other information transmitted from a sender is not conditioned on a receiver responding or transmitting information to the sender.

By way of example, one problem resulting from this deficiency is that traditional messaging services and applications render a negative psychological impact on their users. Viewing or listening to a message does not require a response from the message's receiver, and these traditional services often do not provide any additional incentive to respond to a message. A message sent may go unanswered for a prolonged period of time or may not be answered at all, triggering psychological fears of rejection in the sender.

This psychological fear of rejection may be particularly pronounced in those of a younger age demographic, as they frequently experience greater vulnerability when partaking in such information exchanges. This negative psychological impact may also be particularly problematic for those using traditional messaging in a negotiation or other commercial context, as a sender in that context whose message is unreturned is already experiencing vulnerability by having disclosed potentially sensitive business information.

### SUMMARY OF THE INVENTION

It would be desirable to have a system and method for exchanging information, including, for example, communications such as text messages, multimedia messages, and e-mails between users' communications devices (e.g., mobile devices, personal computers, servers) wherein the disclosure of a sender's information and/or communication to an intended receiver is conditioned upon the intended receiver's transmission of a communication and/or other information in response to an alert of the sender's communication. That is, before the sender's information and/or communication is disclosed to the intended receiver, the system or method would verify that the intended receiver has transmitted an appropriate responsive communication and/or other information.

Various systems, computer products, and methods herein disclose such a system, which may allow the sender's information and/or communication, and the receiver's response information and/or communication, to be exchanged and/or disclosed contemporaneously. The exchange and/or disclosure of communications in such a manner could, for example, avoid the negative psychological impact that often results from traditional messaging application services where communications may remain unanswered for prolonged periods of time or may never be answered at all. Moreover, conditioning the transmission of a communication on a respondent/intended recipient's responsive activity may stimulate better responsiveness because the respondent to an alert of an original, unknown message may be more intrigued or excited by the alert of the unknown message, which will be immediately transmitted and/or disclosed to the respondent upon the transmission of the respondent's response activity.

### DETAILED DESCRIPTION OF THE INVENTION

The system of the present invention may include, in some embodiments, a conditional information exchange server, which may be referred to generically herein as “the server.” In some embodiments of the present invention, the server may be adapted to communicate and interface with one or more rules databases, message databases, and/or profile databases. Further, the profile and rules databases may be adapted to interface and communicate with one another. The function of the server and databases are disclosed herein. Further, references to a “database” should be assumed to refer to “one or more databases.” The system of the present invention may include one or more mobile communication networks, over which information may be conditionally and/or contemporaneously exchanged. The one or more mobile communications networks may be referred to generically herein as “the network.” The server may be adapted to interface and/or communicate with, and to transmit and receive information over the network. Further, the present invention may include communication devices, which may be adapted to run an Internet, wired, wireless, or mobile application that facilitates the conditional exchange of information. Any of these Internet, wired, wireless, or mobile applications may be referred to generically herein as “software application.”

In some embodiments of the present invention, a communication device (e.g., mobile phone, computer tablet, personal computer) may concurrently function as and/or constitute the server. Wherein at least one communication device concurrently functions as and/or constitutes the server, such an embodiment may facilitate the exchange of information between communication devices over, for example, a relatively short distance (e.g., communication devices in the same room or building) by way of bluetooth. Further, in other embodiments wherein at least one communication device concurrently functions as and/or constitutes the server, the communication devices may exchange information over wireless or hard line connection, which may, in some instances, permit the exchange of information over great distances. These embodiments, and the distance attributes, are non-limiting.

In some embodiments, the conditional and/or contemporaneous exchange of information will occur between a “sender,” and “intended receiver” or “receiver.” The “sender” may be defined herein as a party operating a communication device running the software application and who first initiates a potential conditional and/or contemporaneous exchange of information by transmitting over the network a conditioned communication and/or other information, which may or may not ultimately be disclosed to its “intended receiver” or “receiver.” The “intended receiver” or “receiver” may be defined herein as a party operating a communication device running the software application to which “the sender” directs his or her communication and/or information, and who must respond with the appropriate information before the “sender's” communication and/or information is disclosed. “Intended receiver” and “receiver” are used interchangeably throughout this disclosure. Further, this disclosure makes clear that in engaging with the system of the present invention through multiple iterations, a “sender” need not remain a “sender.” That is, a “sender” may, at some point, assume the role of an “intended receiver” or “receiver,” and vice versa.

In some embodiments of the invention, the sender uses a communication device, for example, a mobile device, personal computer, or server adapted to generate and send a communication and/or other information over the network to a receiver. In some embodiments, the communication device may be adapted to send a conditioned communication and/or other information over the network by accessing and/or running a software application. In some embodiments, the sender's device will also be adapted to receive a responsive communication and/or other information from a receiver as transmitted or communicated from a server. In some embodiments, the sender's communication device will also be adapted to receive a conditioned message and/or other information from a different sender as transmitted or communicated from a server when assuming the role of a receiver.

In some embodiments of the invention, the sender will select to initiate the transmission of a communication and/or other information to an intended receiver over the network. The sender may initiate the transmission, for example, by first selecting or inputting the information to transmit via a graphical user interface (“GUI”) of the software application exposed on his or her communication device, and selecting an area of the GUI dedicated to confirming the initiation of the transmission (i.e., a “send” button). A person of ordinary skill will recognize that initiating the transmission of a communication and/or information can be accomplished by a variety of other means, including, for example, voice or motion commands.

In some embodiments of the present invention, the information a sender transmits may include, for example, communications such as text messages, voice messages, audio messages, picture messages, video messages, location messages, e-mail, and combinations of the foregoing. In some embodiments of the invention, the message content may be captured and/or originally created by the sender by means of a mobile device. In still other embodiments, the message content may be downloaded or saved from the Internet or other external source onto a sender's mobile device or other communication device. For example, a sender may include in his or her conditioned communication a video, music, and/or audio file downloaded from the Internet onto his or her communication device. Additionally, in some embodiments, the sender's message may include a link to a URL, which may in some instances include a related image and/or text. In some embodiments, the link to the URL may allow a receiver to stream content through the interface of a software application adapted to facilitate the conditioned and/or contemporaneous exchange.

In addition to the foregoing, a sender may transmit, for example, attributes related to the sender, and other information, such as the sender's geospatial position and related information, the sender's identification information, the intended receiver's identification information, the date and time of the communication's transmission, the sender or receiver's social networking accounts and activity information, the sender or intended receiver's activity on the software application (e.g., frequency of sending/receiving messages, idle time, history between the sender and receiver), and other data to ensure the secure transmission of the communication and network security. In many implementations of the invention, the sender need not manually select or input this information via the software application GUI, or otherwise, to cause its transmission over the network.

Hereinafter, references to “information” may include both the forms of communication and data discussed in paragraph 16 and the other information discussed in paragraph 17, unless the disclosure or context dictates otherwise.

In some embodiments of the invention, the sender's information will be transmitted over the network to a server, or otherwise communicated to a server, adapted to receive, store, and/or later transmit the information. In some embodiments of the invention, the server may interface with one or more message databases, which may be adapted to store the information transmitted, for example, the types discussed in paragraphs 16-17. Further, in some embodiments of the invention, the server may also interface with one or more rules databases. The rules database may include rules, which, in some implementations of the invention, contain one or a logical combination of variables that define actions the server or other components comprising the system of the present invention should execute. One or more of the rule databases may include the logic coded in the software application adapted to send or receive information in the present invention.

Upon receipt of the sender's transmitted information at the server, one or more rules from the rules database may be triggered which cause the server or other system components to verify the identity of the sender or intended receiver. In some embodiments of the present invention, a rule may specify a condition that the information (e.g., communication) originally transmitted from the sender should be retained on the server—and not transmitted to the intended receiver's communication device—at least until the server verifies that the intended receiver has transmitted an acceptable response to an alert of the sender's conditioned communication. Accordingly, the rule to retain the sender's conditioned communication on the server may be triggered when the sender's conditioned communication is received at the server and/or stored on the message database.

In some embodiments of the invention, a rule from the rules database may specify that at some point in time after a sender's transmitted information is received at the server, a notification message (e.g., an alert) is to be transmitted to the communication device of the intended receiver. Accordingly, the server's reception of the sender's communication and/or other information, and/or the storage of the communication and/or other information on the message database may trigger this rule and cause the server to communicate the notification (alert) message over the network to the intended receiver's communication device, which may be adapted to receive such notification (alert) message by way of a software application.

The notification (alert) message, when exposed to the intended receiver, may communicate, for example, the sender's identity, the type of information sent (e.g., text, picture, video clip), the time the sender originally transmitted the information, historical information regarding prior information exchanges between the sender and intended receiver, that the intended receiver is precluded from receiving and/or viewing the sender's conditioned communication in full on his or her communication device until certain responsive information is transmitted, or any combination of the foregoing.

The software application may include a GUI adapted to display the content of the notification (alert) message and related graphics. Further, the notification (alert) message may additionally include a related auditory notification. Upon receiving this notification (alert) message, the software application's GUI may display a blank or locked region where the sender's transmitted information may eventually be displayed if the server verifies the intended receiver has transmitted an appropriate response. In some embodiments, the notification (alert) message may not be perceived until an intended receiver opens the software application.

In some embodiments, the sender may set, alter, or customize one or more rules in the rules database that will be applied to his or her information exchanges. The rules, in some embodiments, relate to the sender's profile settings or preferences. Particular settings, and other information related to senders (or receivers), may be stored in a profile database, which may interface and communicate with the rules database to effectuate a sender's (or receiver's) settings or customized rules. In some embodiments, the sender (or receiver) may customize the rules and/or user settings via the portion of the software application GUI dedicated to establishing or modifying a sender's (or receiver's) profile settings.

For example, rather than entirely preclude the disclosure of the sender's transmitted information to an intended receiver before a responsive transmission, a sender may set, alter, or customize a rule(s) and/or setting(s) that causes the partial disclosure of the sender's information on the intended receiver's communication device, even if the intended receiver has not yet provided appropriate responsive information.

For example, when transmitting a photo message to an intended receiver, the sender may choose, prior to or at the time of effecting the transmission, that information related to the photo should be released from the server and transmitted to the intended receiver prior to a response, but at the same time, further require that the photo be only partially displayed on the intended receiver's communication device. That is, prior to an appropriate response, the sender may choose, for example, that his or her photo be displayed on the software application interface as blurred and/or smeared, or, as another example, that only a peephole of the image be exposed to the sender. In this way, the intended receiver may remain enticed or otherwise incentivized to transmit a responsive communication.

There are various ways to effect the partial disclosure of the sender's communication prior to the intended receiver's response communication. In some embodiments, the sender's original message—for example, a photo—is processed on the sender's phone to create a new, distinct distorted image wherein there is a partial disclosure quality (e.g., smeared, blurred, or with only a peephole visible), while preserving the original photo. In some embodiments, when the sender chooses to send that photo message (assuming a partial disclosure setting is activated), the original, undistorted photo and the distorted image are both transmitted to the server from the sender's communication device. The distortions and the information to which they apply mentioned in this disclosure are merely exemplary and in no way limiting.

Upon receipt at the server, in some embodiments, the server may transmit only the distorted image to the intended receiver's communication device before verifying a response communication, and that distorted image may be displayed on the intended receiver's communication device prior to the verification of the response communication. In such an embodiment, the server may transmit the original, undistorted photo to the intended receiver's communication to be displayed upon verifying the intended receiver's response communication. Alternatively, in other embodiments, upon receipt of the original photo and distorted image at the server, the server may initially transmit both the original photo and the distorted image to the intended receiver's communication device prior to a response communication from the intended receiver. While both the original photo and the distorted image are stored locally on the intended receiver's device, the software application will be adapted such that only the distorted image is displayed prior to verification of an appropriate response communication from the intended receiver. Upon verification, the server will communicate with the intended receiver's communication device to release and display the original, undistorted photo locally stored.

In other embodiments, when the sender chooses to send, for example, a photo message and a partial disclosure setting is activated, only the original, undistorted photo will be transmitted to the server from the intended receiver's communication device. Included in that transmission, however, will be embedded metadata, providing instructions to the server regarding how the original photo should be processed to create a new, distinct distorted photo to be displayed prior to verification of the intended receiver's response, while preserving the original photo. In such an embodiment, the server will use the metadata to process the original photo to create the new, distinct distorted image while preserving the original photo. At that point, and prior to verification of the intended receiver's response communication, the server may transmit to the intended receiver only the distorted image, or both the distorted image and original photo, similar to the process described in paragraphs 27-28. Further, the server may otherwise communicate with the intended receiver's communication device as discussed in paragraphs 27-28.

In other embodiments, when the sender chooses to send, for example, a photo message and a partial disclosure setting is activated, only the original, undistorted photo will be transmitted to the server from the intended receiver's communication device. Included in that transmission will be metadata or other digital instructions regarding how the original photo should be processed to create a new, distinct distorted photo to be displayed prior to verification of the intended receiver's response. In this embodiment, the server may transmit the original photo and metadata (or other digital instructions) received from the sender to the intended receiver's device. In such an embodiment, the software application on the intended receiver's device will be adapted to use the metadata or other digital instructions to process the original photo to create a new, distinct distorted image, while preserving the original photo. In such an embodiment, similar to others, the software application is adapted to display only the distorted image at least until the verification of an appropriate response communication.

It should be appreciated that while the foregoing examples discuss in many instances photo messages, the methods described could be applied to a wide variety of message types. In other words, there could be a variety of “original” and “distorted” message types (textual, video, hyperlink) to effectuate the partial disclosure of a communication. Further, it could be appreciated that similar methods could be used even in the event no partial disclosure setting is activated.

In some embodiments, the partial disclosure (i.e., disclosure of the distorted message) may occur at or around the time the notification (alert) message is communicated. The partial disclosure (i.e., disclosure of the distorted message) may be displayed in the portion of the software GUI on the intended receiver's device that is otherwise locked or left blank upon the receipt of a notification (alert) message when the sender's message is not disclosed whatsoever. Further, it should be appreciated that in some embodiments of the present invention, the partial disclosure may be a default setting. In other words, the sender or intended receiver need not modify any rule or setting for the system to cause a partial disclosure.

In some implementations of the invention, at some point after receiving the notification (alert) message and/or partial disclosure, the intended receiver may choose to transmit a responsive communication in order to release the sender's information from the server or message database in order to transmit it to his or her communication device via the network, or to otherwise fully disclose a communication (e.g., display and/or communicate an original, undistorted message in the event of an initial partial disclosure). In some embodiments of the invention, one or more rules from the rules database may allow for the intended receiver to respond with any type of information to release and cause the transmission of the sender's information retained on the server and/or message database or to otherwise fully disclose a communication, facilitating a contemporaneous information exchange.

In some embodiments, to effect the transmission of responsive information, the intended receiver may select the software's GUI in a designated area (i.e., a “respond” button), which may include a portion of the intended receiver's GUI left blank or locked, or otherwise displaying a partially disclosed communication. The intended receiver may then, for example, select the information to transmit via the GUI, and then select the area of the GUI dedicated to confirming the transmissions initiation (i.e., a “send” button). The information that the intended receiver chooses to communicate may include the communications or other information discussed in paragraphs 16-17.

The responsive information may be transmitted over the network and may be received by the server, or otherwise communicated to the server, which may be adapted to receive these responsive communications. Upon receipt of the intended receiver's information at the server, one or more rules from the rules database may be triggered. For example, a rule may be triggered that causes the responsive information to be stored in the message database. Further, for example, a rule may be triggered that sends an “unlock” alert to the sender and/or receiver. The unlock alert may communicate, for example, that the intended receiver has transmitted the appropriate responsive information, that the sender's transmitted information will be displayed to the receiver, and/or that the receiver's transmitted information will be displayed to the sender. The alert may take a form and be communicated in manner similar to that of a notification (alert) message discussed in paragraphs 21-23, although the message communicated by the “unlock” alert may be distinct. In some embodiments, the “unlock” alert may not be perceived until an intended receiver or sender opens the software application on his or her communication device.

Further, upon receipt of the intended receiver's information at the server, another rule may be triggered that causes the server to transmit the sender's information retained on the server and/or message database to the intended receiver's communication device at or near the same time (contemporaneous) the server transmits the intended receiver's response communication to the sender. Similarly, a rule may be triggered that causes the server to display or otherwise communicate an original, undistorted message to the intended receiver's communication device (e.g., in the event of an initial partial disclosure via a distorted message) at or close in time (contemporaneous) to the server causing the intended receiver's response communication to be transmitted to the sender. In this way, a contemporaneous information exchange is completed between the sender and receiver. Each party's actual consumption of such transmissions (i.e., when each party actually perceives the exchanged communications) will depend on when each party uses their communication device adapted with the software application to access the exchanged information. Further, as previously noted, the rules driving the contemporaneous exchange, including the rules on the rules database, may comprise the logic of the software application running on the communication devices.

Paragraphs 33-34 generally describe a scenario in which the intended receiver is able to respond with any type of information to release and transmit the sender's information retained on the database, or otherwise fully disclose a communication that previously had been only partially disclosed. However, in some embodiments, the sender may change or customize one or more rules in the rules database that will be applied to his or her information exchanges. The rules, in some embodiments, relate to the sender's profile settings or preferences. For example, the sender may change a rule or setting to require that the intended receiver respond with a message of a specific medium—for example, a picture or video message—or a particular combination of communications, such as a picture message with a textual overlay.

By way of further example, the sender may require the intended receiver to respond with a message or file of a certain format type, for instance, .jpg or .gif, or a certain file size. In another, non-limiting example, the sender may place a time limitation on the intended receiver's response. That is, the sender may require the intended receiver to respond within a certain time after the sender's initial transmission of information or otherwise forfeit the ability to respond. By way of further example, a sender may require an intended receiver to respond with content originally created by the intended receiver, as opposed to information downloaded from the Internet or obtained from other sources. The software application may be adapted to determine whether an intended receiver's content is original (i.e., whether it was created by that intended receiver) by tracking data related to the information transmitted, for example, the time when the information was created (as compared to the sender's initial transmission time), any geographical tags associated (which may be compared to the intended receiver's current or historical geospatial location), and/or the results from running the intended receiver's information through a text or image-based internet search (which may reveal that the exact or similar data is available online).

In another example, the sender may require that the intended receiver transmit a response over the network to a website or third party as opposed to transmitting the information to the sender's communication device. For example, the sender may require that the intended receiver respond by posting information on Facebook or Twitter, by “like”-ing a particular item on Facebook, or by following a particular individual or entity on Facebook or Twitter. In such a scenario, the software application may be adapted to transmit an appropriate confirmation to the server to confirm the intended receiver's transmission, even if no responsive communication from the intended receiver is transmitted to or stored on the server or message database.

In the event that the intended receiver does not send the appropriate response as mandated by the sender's preferences or customized rules (or default rules), a rule may be triggered causing the server to send a “failure” notice to the sender and/or intended receiver, which may communicate, for example, that the intended receiver's transmission did not comply with the sender's preferences and/or rules (or default rules), and/or that the intended receiver must send a new, complying transmission in order to release the sender's information retained on the server or message database, or to otherwise fully disclose a communication on the intended receiver's communication device (e.g., only a distorted message was previously displayed). In some embodiments, the failure notice may not be perceived until an intended receiver or sender opens the software application on his or her communication device.

While the present invention contemplates the exchange of information between friends, family, acquaintances, and strangers, the present invention may also be used in business, advertising, and other commercial applications—for example, between a business and consumer. The exchange of information in this context may be executed consistent with any description of the invention as disclosed herein. The descriptions that follow are non-limiting.

For example, a business entity (including representatives) acting as a sender may initiate a transmission to a consumer acting as an intended receiver, or vice-versa. For example, the business entity (sender) may conditionally transmit information over the network toward an intended receiver, and that information may include sales opportunities, new product promotions, or other advertisements communicated by a variety of digital media (text, videos, graphics). In some embodiments, the information transmitted by the business entity (sender) will not be released from the server which received that information and transmitted to the consumer's (intended receiver's) communication device until the server receives and verifies an appropriate responsive communication from the consumer. Alternatively, in other embodiments, the business entity (sender) may set or alter rules from the rules database and/or user settings and allow for the partial disclosure of the information it transmitted on the consumer's (intended receiver's) communication device, even if an appropriate response has not yet been provided by the consumer.

Further, as previously described herein, the business entity may, in some embodiments, set, customize, or alter rules from the rules database and/or user settings, so that the consumer is required to transmit certain information to release the business entity's information from the server, or otherwise effectuate the full disclosure of information in the event of an initial partial disclosure (i.e., only a distorted message is displayed on the communication device). For example, the business entity may require that the consumer respond with certain personal information (e.g., age, location, personal preferences), and/or to respond with a message of a certain format (picture, video message). In some embodiments, the business entity may require a consumer's responsive message, whether a picture or video or otherwise, to incorporate the business entity's product and/or logo. The software application may be adapted to visually recognize whether such product and/or logo appears in the response. In other scenarios, a business entity may require a consumer to post about the business on Facebook or Twitter, “like” the business entity's facebook page, or follow the business entity on Twitter and/or Facebook.

The present invention may, in some embodiments, facilitate the exchange of information between business entities or other parties engaged in negotiations. For example, the present invention may allow the contemporaneous exchange of information regarding the terms of a potential transaction or contract. The parties (sender and intended receiver) may set, alter, or customize their rules from the rules database and/or user settings to require that the sender's initial message and/or the intended receiver's response meet certain criteria. For example, the sender and/or intended receiver may require that the proposed terms for a contract to be exchanged fall within a particular dollar value range.

The present invention, in some embodiments, contemplates an iterative exchange of information. That is, after an appropriate response has been sent by the intended receiver, and the contemporaneous exchange is executed, the parties may initiate and execute subsequent conditioned and contemporaneous exchanges. In some embodiments, this iterative process may be captured and displayed on the software application's GUI via a thread. It should be appreciated that a sender from a previous exchange may be an intended receiver in a later exchange, and vice-versa.

Further, the present invention may be adapted to handle group messaging. That is, a sender may transmit conditional information to a plurality of intended receivers. In some embodiments, the intended receivers' responses to the group message may be displayed on a software application's GUI via a single thread, even to other intended receivers. In other embodiments, only the sender will have the ability to perceive the intended receivers' response communications. In some embodiments, the GUI will be adapted to display to the intended receivers and/or senders in the group who have responded, and other information related to the response, such as the time sent. In some instances, the receivers in a group message may not be made aware that they partaking in a group message.

In some embodiments, the software application may be adapted to identify other users of the software application by accessing the phonebook on one's communication device, or accessing information related to one's social media accounts, for example, Facebook and Twitter. The software application may also be adapted to provide users the opportunity to confirm that they intend to engage in conditional exchanges with other users (i.e., friending). Further, the GUI of the software application of the present invention may be adapted to display one's “friends” in a way that visually arranges those friends based on the frequency of one's engagement with those friends via the software application.

The GUI of the software application may also be adapted to display a variety of information related to the user's activity on the application. For example, the GUI may display the number of completed conditioned exchanges (which may be further broken down by whether the user was sender or intended receiver), the number of communications sent as a sender to which there has been no response, and/or the number of messages for which the user is an intended receiver and for which the user must respond to fully release the message. The application may also be adapted to permit user commentary (i.e., “comments”) to be associated with an information exchange, and the GUI may be adapted to visually associate these comments with the communications.

The foregoing discussion of the present invention's software application and GUI is non-limiting and in no way exclusive.

That which is claimed:

1. A method for providing a conditional exchange of information, comprising:
receiving, by one or more servers, a communication by a sender originally transmitted from the sender's communication device;
determining, by the one or more servers, an identity of the sender of the communication and a conditional transmission rule established for the communication by the sender;
storing, by the server, the sender's communication to an intended receiver;
communicating, by the server, a notification to the intended receiver's communication device;
receiving, by the server, a response communication from the intended receiver originally transmitted from the intended receiver's communication device;
determining, by the server, whether the intended receiver's response communication satisfies the conditional transmission rule;
contemporaneously communicating, by the server, the sender's communication to the intended receiver's communication device, and the intended receiver's response communication to the sender's communication device.

2. The method of claim 1, wherein the sender's communication includes information to identify the sender's geospatial location.

3. The method of claim 1, wherein the sender's communication includes identification information.

4. The method of claim 1, wherein the sender's communication includes the date and time of the communication.

5. The method of claim 1, wherein the sender's communication includes social media information.

6. The method of claim 1, wherein the conditional transmission rule includes the requirement that the intended receiver's response communication comprises information in a specific format.

7. The method of claim 1, wherein the conditional transmission rule includes the requirement the intended receiver's response communication comprises a file of a certain extension type.

8. The method of claim 1, wherein the conditional transmission rule includes the requirement the intended receiver's response communication is transmitted within a specific time period.

9. The method of claim 1, wherein the conditional transmission rule includes the requirement the intended receiver's response communication is within a specific file size range.

10. The method of claim 1, wherein the conditional transmission rule includes the requirement the intended receiver's response communication comprises data originally created by the intended receiver.

11. The method of claim 1, wherein the conditional transmission rule includes the requirement the intended receiver's response communication comprise an image with specific content.

12. The method of claim 1, wherein the conditional transmission rule includes the requirement the intended receiver's communication comprise personal information about the intended receiver.

13. A method for providing a conditional exchange of information, comprising:
creating, by a sender's communication device, an altered message from an original message, while preserving the original message, and wherein the altered message partially discloses the original message;
receiving, by one or more servers, a communication by a sender originally transmitted from the sender's communication device, wherein the communication comprises both the original message and the altered message;
determining, by the one or more servers, an identity of the sender of the communication and a conditional transmission rule established for the communication by the sender;
communicating, by the server, a notification to the intended receiver's communication device;
further communicating, by the server, the portion of the sender's communication comprising the altered message to the intended receiver's communication device;
causing, by the server, a graphical user interface to be exposed on the intended receiver's communication device, wherein the interface displays the altered message;
receiving, by the server, a response communication from the intended receiver originally transmitted from the intended receiver's communication device;
determining, by the server, whether the intended receiver's response communication satisfies the conditional transmission rule;
contemporaneously causing, by the server, the portion of the sender's communication comprising the original message to be communicated to the intended receiver's communication device, and the intended receiver's response communication to be communicated to the sender's communication device.

14. A method for providing a conditional exchange of information, comprising:
creating, by a sender's communication device, an altered message from an original message, while preserving the original message, and wherein the altered message partially discloses the original message;
receiving, by one or more servers, a communication by a sender originally transmitted from the sender's communication device, wherein the communication comprises both the original message and the altered message;
determining, by the one or more servers, an identity of the sender of the communication and a conditional transmission rule established for the communication by the sender;
communicating, by the server, a notification to the intended receiver's communication device;
further communicating, by the server, the sender's communication to the intended receiver's communication device;
causing, by the server, a graphical user interface to be exposed on the intended receiver's communication device, wherein the interface displays only the altered message portion of the sender's communication;
receiving, by the server, a response communication from the intended receiver originally transmitted from the intended receiver's communication device;
determining, by the server, whether the intended receiver's response communication satisfies the conditional transmission rule;
contemporaneously causing, by the server, the portion of the sender's communication comprising the original and unaltered message to be displayed on graphical user interface of the intended receiver's communication device, and the intended receiver's response communication to be communicated to the sender's communication device.

15. A method for providing a server-mediated conditional exchange of electronic information, comprising:
receiving, by one or more servers, an original electronic communication by a sender originally transmitted from the sender's communication device, wherein the communication is directed toward a plurality of intended receivers;
determining, by the one or more servers, an identity of the sender of the communication and an identity of one or more of the intended receivers;
sending, by the one or more servers, an altered electronic copy of the sender's original communication to the communication device(s) of the intended receiver(s) for which the identity was determined by the one or more servers, wherein the altered electronic copy is viewable on the intended receiver(s)' communication device(s) but a complete and unaltered electronic copy of the sender's original communication is not yet viewable on the intended receiver(s)' communication device(s);
applying a conditional transmission rule associated with the original communication, wherein the conditional transmission rule requires at least a response communication from an identified intended receiver's communication device in order for a complete and unaltered electronic copy of the sender's original communication to be viewable on that intended receiver(s)' communication device(s);
receiving, by the server, a response communication(s) from one or more of the identified intended receivers, originally transmitted from the intended receiver(s)' communication device(s);
determining, by the server, whether the conditional transmission rule is satisfied for a particular intended receiver;
when the conditional transmission rule is satisfied for a particular intended receiver, contemporaneously communicating, by the server, information sufficient to make viewable on that intended receiver's communication device: (i) the complete and unaltered electronic copy of the sender's original communication, and (ii) the response communication(s) of any other identified intended receiver(s) from the plurality who have satisfied the rule.

16. A method for providing a server-mediated conditional exchange of electronic information, comprising:
receiving, by one or more servers, an original electronic communication by a sender originally transmitted from the sender's communication device, wherein the communication is directed toward one or more intended receivers;
determining, by the one or more servers, an identity of the sender of the communication and identities of the one or more intended receivers;
sending, by the one or more servers, the sender's original communication to the communication device(s) of the intended receiver(s) for which the identity was determined by the one or more servers,
creating, by the intended receiver(s)' communication device(s), an altered electronic copy of the sender's original communication, wherein the altered electronic copy is viewable on the intended receiver(s)' communication device(s) but the complete and unaltered electronic copy of the sender's original communication is not yet viewable on the intended receiver(s)' communication device(s);
applying a conditional transmission rule associated with the original communication, wherein the conditional transmission rule requires at least a response communication from an identified intended receiver's communication device in order for the complete and unaltered electronic copy of the sender's original communication to be viewable on that intended receiver(s)' communication device(s);
receiving, by the server, a response communication(s) from one or more of the identified intended receivers, originally transmitted from the intended receiver(s)' communication device(s);
determining, by the server, whether the conditional transmission rule is satisfied for a particular intended receiver;
when the conditional transmission rule is satisfied for a particular intended receiver, contemporaneously communicating, by the server, information sufficient to make viewable on that intended receiver's communication device the complete and unaltered electronic copy of the sender's original communication; and the intended receiver's response communication to the sender's communication device.

17. A method for granting conditional access to a server-based collection of electronic messaging content, comprising:
receiving, by one or more servers, messaging content from a plurality of senders originally transmitted from the senders' communication devices, wherein the electronic messaging content is directed to contribute to a collection of electronic messaging content to which conditional access will be granted;
determining, by the one or more servers, an identity of one or more senders of electronic messaging content;
applying a conditional access rule, wherein the conditional access rule grants access to a particular sender to the collection of electronic messaging content stored on the one or more servers for a limited period of time only when the server receives at least electronic messaging content from that sender;
determining, by the server, whether the conditional access rule is satisfied for a particular sender;
when the conditional access rule is satisfied by a particular sender, storing, by the one or more servers, the electronic messaging content of that sender who satisfied the rule to the collection of electronic messaging content; and transmitting, by the server, information to the communication device of that sender sufficient to grant that sender access to the collection of messaging content for a limited period of time.
